(19) United States
(12) Patent Application Publication
(10) Pub. No.: US 2026/0197854 A1
(43) Pub. Date: Jul. 9, 2026

(54) COMMUNICATION TERMINAL AND CONTROL METHOD

(71) Applicant: SHARP KABUSHIKI KAISHA, Sakai City, Osaka (JP)

(72) Inventors: TOSHIYUKI NOBUOKA, Sakai City, Osaka (JP); TOMOKO UEKI, Sakai City, Osaka (JP); Takumi NISHINA, Sakai City, Osaka (JP); SHUN UEKI, Sakai City, Osaka (JP)

(21) Appl. No.: 19/123,978

(22) PCT Filed: Sep. 7, 2023
(86) PCT No.: PCT/JP2023/032592

§ 371 Date: Apr. 24, 2025

(30) Foreign Application Priority Data
Oct. 31, 2022 (JP) 2022-173871

(51) Int. Cl. H04W 72/542; H04W 72/02

(52) U.S. Cl. CPC H04W 72/542; H04W 72/02

(57) ABSTRACT

A communication terminal includes: a reception unit that switches channels for selection from a plurality of channels on a per scan interval basis and receives a signal on the selected channel; and a controller that causes the reception unit to receive the signal during a reception time period extending across a plurality of scan intervals at which the channels are respectively selected.

### TECHNICAL FIELD

The present disclosure relates to a communication terminal, a control method and a program. The present application is based on and claims priority from Japanese Patent Application No. 2022-173871 filed Oct. 31, 2022, in Japan and the contents of the application are incorporated herein by reference.

### BACKGROUND ART

Patent Literature 1 discloses a technique that sets, in accordance with a packet loss rate, a scan time period that is a multiple of transmission intervals of a beacon signal.

### CITATION LIST

### Patent Literature

PTL 1: US Patent Publication U.S. Pat. No. 10,499,361 B2

### SUMMARY

### Technical Problem

Variations in reception power may occur depending a channel that is a frequency band used to receive a signal. In the technique disclosed in PTL 1, the variations in the reception power depending on the channel may lead to a relatively large error in position fixing based on a reception strength of a beacon signal. Furthermore, in the technique disclosed in PTL 1, a relatively longer time period is to be used to receive the beacon signal in order to reduce the error in the position fixing based on the reception strength of the beacon signal. Therefore, the object of an aspect of the disclosure is to provide a communication terminal, a control method and a program that may receive sufficient signals with the reception time period reduced.

### Solution to Problem

A communication terminal according an embodiment of the disclosure includes a reception unit that switches channels for selection from a plurality of channels on a per scan interval basis and receives a signal on the selected channel; and a controller that causes the reception unit to receive the signal during a reception time period extending across a plurality of scan intervals at which the channels are respectively selected.

A communication terminal according to another embodiment of the disclosure includes a reception unit that switches channels for selection from a plurality of channels on a per scan interval basis and receives at specific intervals a signal that is transmitted on the selected channel; and a controller that causes the reception unit to receive the signal during a reception time period that is shorter than the scan interval and within which a count of receptions of the signal exceeds a threshold.

A control method according an embodiment of the disclosure includes switching channels for selection from a plurality of channels on a per scan interval basis and receiving a signal on the selected channel; and controlling a reception time period extending across a plurality of scan intervals at which the channels are respectively selected, such that the signal is received during the reception time period.

A control method according to another embodiment of the disclosure includes switching channels for selection from a plurality of channels on a per scan interval basis and receiving at specific intervals a signal that is transmitted on the selected channel; and controlling a reception time period such that the reception time period is shorter than the scan interval and a count of receptions of the signal exceeds a threshold within the reception time period.

A program according to an embodiment of the disclosure causes a computer to perform: a function of switching channels for selection from a plurality of channels on a per scan interval basis and receiving a signal on the selected channel; and a function of controlling a reception time period extending across a plurality of scan intervals at which the channels are respectively selected, such that the signal is received during the reception time period.

A program according to another embodiment of the disclosure causes a computer to execute: a function of switching channels for selection from a plurality of channels on a per scan interval basis and receiving at specific intervals a signal that is transmitted on the selected channel; and a function of controlling a reception time period such that the reception time period is shorter than the scan interval and a count of receptions of the signal exceeds a threshold within the reception time period.

### BRIEF DESCRIPTION OF DRAWINGS

FIG. 1 is a block diagram illustrating an example of the entire configuration of a communication system.

FIG. 2 is a block diagram illustrating an example of the configuration of a transmission terminal.

FIG. 3 is a block diagram illustrating an example of the configuration of a communication terminal according to a first embodiment.

FIG. 4 is a block diagram illustrating an example of a reception signal log according to the first embodiment.

FIG. 5 is a block diagram illustrating an example of the configuration of a server apparatus.

FIG. 6 is a flowchart illustrating an example of the process of the communication terminal according to the first embodiment.

FIG. 7 is a flowchart illustrating an example of the process of the server apparatus.

FIG. 8 is a diagram illustrating an example of a reception time period and data transmission period.

FIG. 9 is a block diagram illustrating an example of the configuration of a communication terminal according to a second embodiment.

FIG. 10 is a flowchart illustrating an example of the process of the communication terminal according to the second embodiment.

FIG. 11 is a diagram illustrating an example of a signal that is received at scan intervals on each channel in the communication terminal according to the second embodiment.

FIG. 12A is a graph illustrating an example of a reception strength.

FIG. 12B is a graph illustrating an example of a time variation of the mean value of the reception strength.

FIG. 13 illustrates an example of operations in step S1001-step S1002 illustrated in FIG. 10.

FIG. 14 is a block diagram illustrating an example of the configuration of a communication terminal according to a third embodiment.

FIG. 15 is a diagram illustrating an example of a reception signal log according to the third embodiment.

FIG. 16 is a flowchart illustrating an example of the process of the communication terminal according to the third embodiment.

FIG. 17 is a diagram illustrating an example of a signal that is received at scan intervals on each channel in the communication terminal according to the third embodiment.

FIG. 18 illustrates an example of operations in step S1601-step S1605 illustrated in FIG. 16.

FIG. 19 is a diagram illustrating an example of the scan interval and a signal received during a reception time period in the communication terminal according to a fourth embodiment.

FIG. 20 is a block diagram illustrating an example of the configuration of a communication terminal according to a fifth embodiment.

FIG. 21 is a block diagram illustrating an example of the process of the communication terminal according to the fifth embodiment.

FIG. 22 is a flowchart illustrating an example of the process of the communication terminal according to the fifth embodiment in succession to FIG. 21.

FIG. 23 is a diagram illustrating an example of the scan interval and the reception time period in the communication terminal according to the fifth embodiment.

### DESCRIPTION OF EMBODIMENTS

### First Embodiment

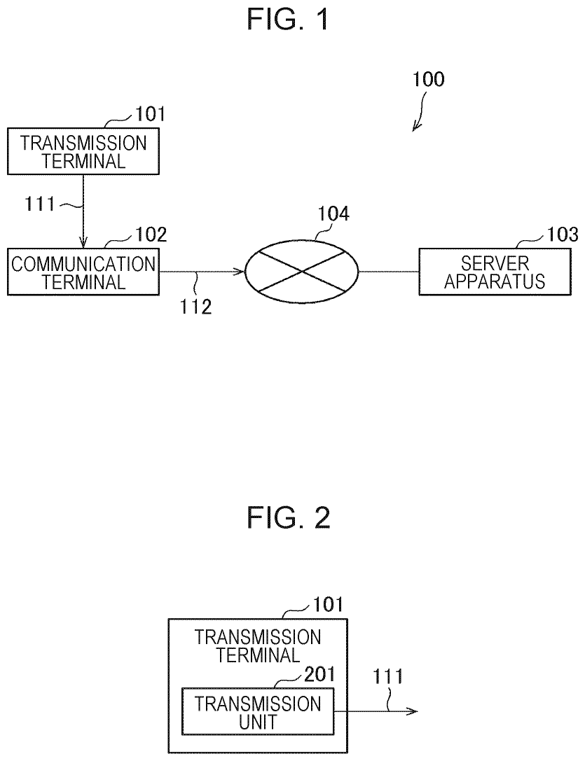

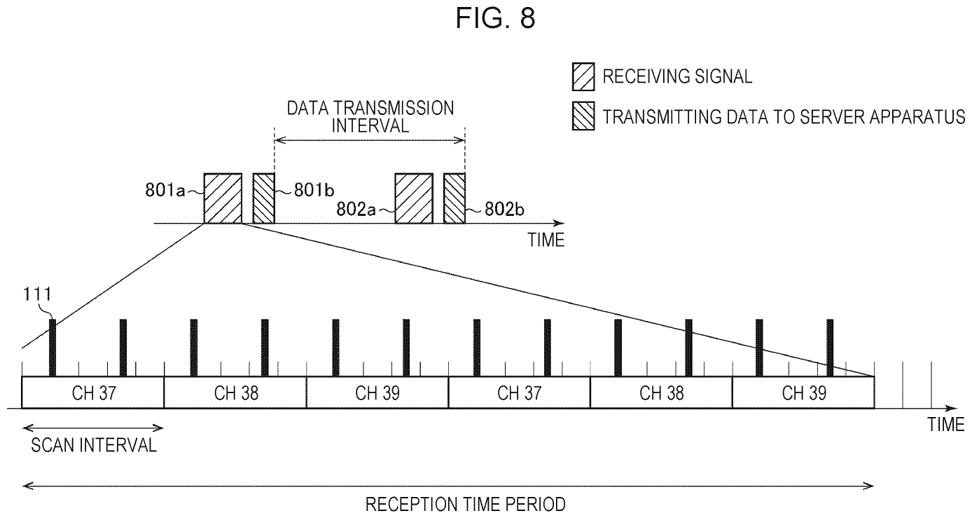

First embodiment is described with reference to FIG. 1 FIG. 8. In the drawings, elements that are the same or similar to each other are designated with the same reference numerals and the explanation thereof is not duplicated.

FIG. 1 is a block diagram illustrating an example of the entire configuration of a communication system 100. The communication system 100 includes a transmission terminal 101, a communication terminal 102, and a server apparatus 103. The communication system 100 may include multiple transmission terminals 101. The communication terminal 102 and the server apparatus 103 are connected to each other via a network 104. For example, the network 104 is a mobile communication network, Wi-Fi (registered trademark), or the like.

The transmission terminal 101 transmits a signal 111 at specific intervals on multiple frequency bands through a near field communication system. Each of the frequency bands is referred to as a channel. Identification information 315 included in the signal 111 indicates identification information on the transmission terminal 101 serving as a source of the signal 111. For example, the identification information 315 on the transmission terminal 101 is Bluetooth (registered trademark) Device Address. For example, channels of Bluetooth (registered trademark) are 79 channels and in position fixing using a Bluetooth beacon, signals transmitted on channel 37-channel 39 are used from among the 79 channels.

The communication terminal 102 receives, on a per scan interval basis, the signal 111 on a channel that is switched for selection among the multiple channels. Furthermore, the communication terminal 102 generates signal data 112 in response to the signal 111 and transmits the generated signal data 112 to the server apparatus 103. For example, the communication terminal 102 may be a smart watch, a card-type device, a smart ring, smart glasses, a clothing type device, or the like.

The server apparatus 103 stores the signal data 112 transmitted from the communication terminal 102 and analyzes the stored signal data 112. The server apparatus 103 outputs analysis results of the stored signal data 112. For example, the signal data 112 indicates the identification information on the transmission terminal 101 serving as a source of the signal 111 in association with a reception strength and the server apparatus 103 fixes the position of the communication terminal 102 by analyzing the reception strength and the identification information on the transmission terminal 101 indicated by the signal data 112. In this case, the server apparatus 103 outputs the position of the communication terminal 102 as the analysis results of the stored signal data 112.

FIG. 2 is a block diagram illustrating an example of the configuration of the transmission terminal 101. The transmission terminal 101 includes a transmission unit 201 and the like.

The transmission unit 201 transmits the signal 111 at specific intervals on multiple frequency bands via a near field communication system. The signal 111 includes the identification information 315 identifying the transmission terminal 101 serving as the source of the signal 111.

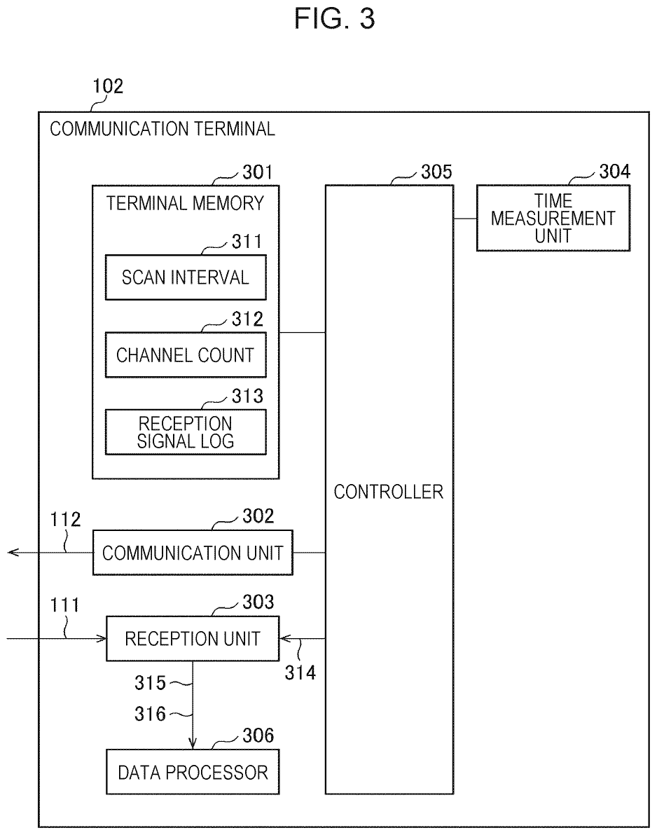

FIG. 3 is a block diagram illustrating an example of the configuration of the communication terminal 102. The communication terminal 102 includes a terminal memory 301, a communication unit 302, a reception unit 303, a time measurement unit 304, a controller 305, a data processor 306, and the like.

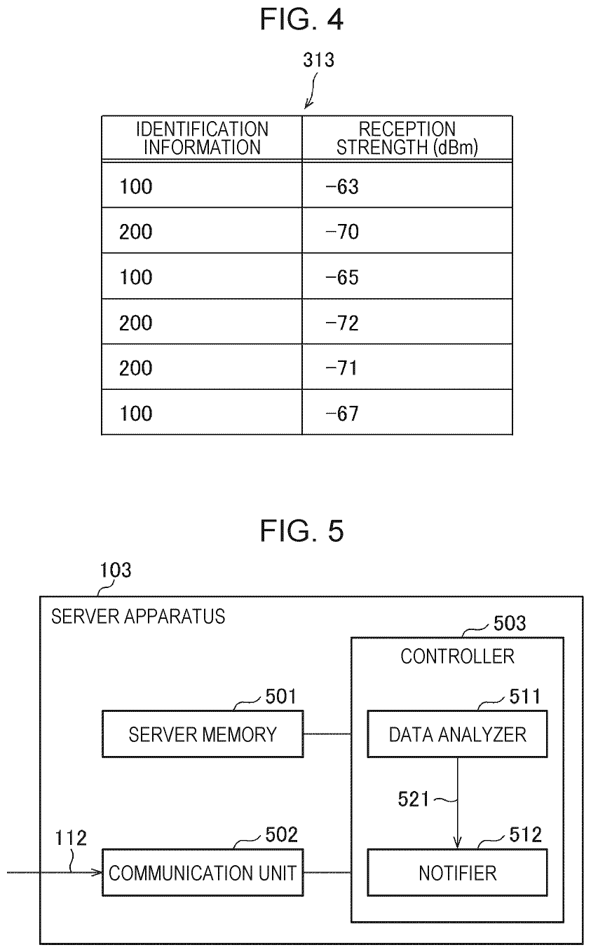

The terminal memory 301 is a recording medium able to record a variety of data, programs, and the like, and includes, for example, a hard disk, SSD (Solid State Device), and a semiconductor memory. The terminal memory 301 stores a scan interval 311, a channel count 312, a reception signal log 313 (see FIG. 4), and the like.

The communication unit 302 is an interface connected to the network 104 for communication. The communication unit 302 transmits to the server apparatus 103 the signal data 112 generated by the data processor 306. The signal data 112 includes a set of identification information 315 on the signal 111 and reception strength 316 of the signal 111.

The reception unit 303 switches channels for selection from multiple channels on each scan interval 311 and receives the signal 111 on the selected channel. Specifically, on each scan interval 311, the reception unit 303 switches channels for selection from the multiple channels and receives on the selected channel the signal 111 that is transmitted at specific intervals. The count of the channels is 312. The specific interval at which the signal 111 is transmitted is shorter than the scan interval 311. For this reason, the signal 111 is received one or more times during the scan interval 311 on each channel.

The time measurement unit 304 calculates elapsed time from the start time point of a reception time period 314.

The controller 305 and the data processor 306 execute a variety of operations in accordance with programs and data stored on the terminal memory 301.

The controller 305 causes the reception unit 303 to receive the signal 111 during the reception time period 314 that extends across multiple scan intervals 311 at which multiple channels are respectively selected. Specifically, the controller 305 causes the reception unit 303 to receive the signal 111 from the start time point of the reception time period 314 to the end time point of the reception time period 314. The reception time period 314 herein has a length extending across multiple scan intervals 311 and multiple channels are selected during the reception time period 314.

Also, the reception time period 314 may be a product of the scan interval 311, the channel count 312, and a specific multiple N. The specific multiple N is an integer greater than or equal to 1 and is predetermined in view of the needed number of signal data 112.

The data processor 306 registers on the reception signal log 313 the identification information 315 included in the signal 111 in association with the reception strength 316 of the signal 111. The data processor 306 further generates the signal data 112. The controller 305 and the data processor 306 may be implemented by a processor, such as a CPU (Central Processing Unit).

FIG. 4 illustrates an example of the reception signal log 313. In the reception signal log 313, the signal 111 received from the start time point of the reception time period 314 to the end time point of the reception time period 314 is associated with the identification information 315 on the signal 111 and the reception strength 316 of the signal 111.

For example, the reception signal log 313 illustrated in FIG. 4 indicates that the reception unit 303 has received the signals 111 including the identification information 315 indicating 100 at the reception strengths 316 of −63 dBm, −65 dBm, and −67 dBm from the start time point of the reception time period 314 to the end time point of the reception time period 314. Furthermore, the reception signal log 313 illustrated in FIG. 4 indicates that the reception unit 303 has received the signals 111 including the identification information 315 indicating 200 at the reception strengths 316 of −70 dBm, −72 dBm, and −71 dBm from the start time point of the reception time period 314 to the end time point of the reception time period 314.

FIG. 5 is a block diagram illustrating an example of the configuration of the server apparatus 103. The server apparatus 103 includes a server memory 501, a communication unit 502, a controller 503, and the like.

The server memory 501 is a recording medium able to record a variety of data, programs, and the like and includes, for example, a hard disk, an SSD, a semiconductor memory, or the like.

The communication unit 502 is an interface connected to the network 104 for communication. The communication unit 502 receives the signal data 112 from the communication terminal 102 via the network 104.

The controller 503 performs a variety of operations in accordance with programs and data stored on the server memory 501. For example, the controller 503 is implemented by a processor, such as a CPU. The controller 503 includes a data analyzer 511, a notifier 512, and the like.

The data analyzer 511 causes the signal data 112 received by the communication unit 502 to be stored on the server memory 501. The data analyzer 511 then analyzes the signal data 112 stored on the server memory 501 and generates analysis result information 521 indicating analysis results.

The notifier 512 notifies a specific destination of the analysis result information 521. For example, the specific destination is a terminal that is different from the communication terminal 102 and used by an administrator or the like of the server apparatus 103.

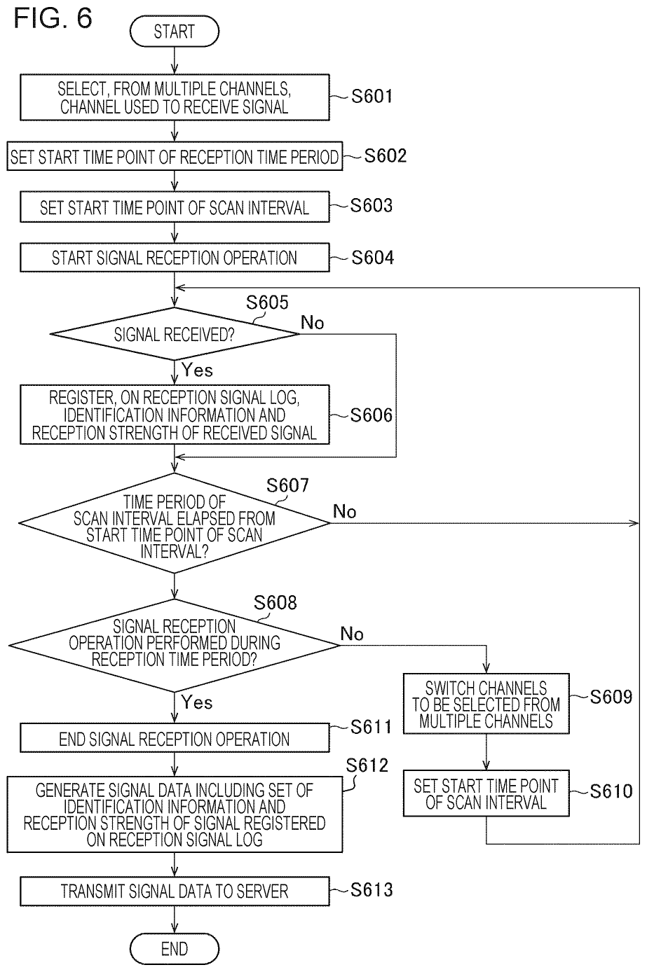

FIG. 6 is a flowchart illustrating an example of the process of the communication terminal 102 of the embodiment.

In step S601, the reception unit 303 selects a channel used to receive the signal 111 from multiple channels. For example, when the position of the communication terminal 102 is fixed using a Bluetooth beacon, the reception unit 303 selects the channel used to receive the signal 111 from channel 37-channel 39.

In step S602, the time measurement unit 304 sets the start time point of the reception time period 314. In step S603, the time measurement unit 304 sets the start time point of the reception time period 314 set in step S602 to be a start time point of each scan interval 311 on the channel set in step S601.

In step S604, the controller 305 causes the reception unit 303 to start a signal reception operation on the selected channel from the start time point of the reception time period 314. When the reception unit 303 starts the signal reception operation, the reception unit 303 waits on standby for the reception of the signal 111 until the signal 111 is received.

In step S605, the controller 305 determines whether the reception unit 303 has received the signal 111. If the reception unit 303 has not received the signal 111 in step S605, the controller 305 proceeds to an operation in step S607. On the other hand, if the reception unit 303 has received the signal 111 in step S605, the data processor 306 registers in step S606 on the reception signal log 313 the identification information 315 included in the received signal 111 in association with the reception strength 316 of the signal 111. The controller 305 then proceeds to the operation in step S607.

In step S607, the time measurement unit 304 determines whether a time period equal to the scan interval 311 has elapsed since the start time point of each scan interval 311. If the time period equal to the scan interval 311 has not elapsed since the start time point of each scan interval 311, the controller 305 returns to the operation in step S605. On the other hand, the time period equal to the scan interval 311 has elapsed in step S607 since the start time point of each scan interval 311, the controller 305 proceeds to an operation in step S608.

In step S608, the controller 305 determines whether the reception unit 303 has performed the signal reception operation for the time period equal to the reception time period 314. If the reception unit 303 has performed the signal reception operation for the reception time period 314, the controller 305 proceeds to an operation step S611.

On the other hand, if the reception unit 303 has not performed the signal reception operation during the reception time period 314 in step S608, the reception unit 303 switches channels for selection among the multiple channels in step S609. Since the reception unit 303 has received the signal 111 during the reception time period 314 extending across the multiple scan intervals 311, variations in the reception strength 316 of the signal 111 received during the reception time period 314 may be reduced. Furthermore, since the reception time period 314 is determined depending on the number of needed signal data 112, the controller 305 may cause the reception unit 303 to receive the signal 111 sufficient number times while precluding the reception time period 314 from becoming unnecessarily long. Then, in step S610, the time measurement unit 304 sets the time point of switching to the selected channel in step S609 to be the start time point of the scan interval 311 on the selected channel. The controller 305 then returns to the operation in step S605.

In step S611, the controller 305 causes the reception unit 303 to end the signal reception operation. At the end of the signal reception operation, the reception unit 303 finishes waiting on standby to receive the signal 111.

In step S612, the data processor 306 generates the signal data 112 including a set of identification information 315 and reception strength 316 registered on the reception signal log 313.

In step S613, the communication unit 302 transmits the signal data 112 to the server apparatus 103 via the network 104.

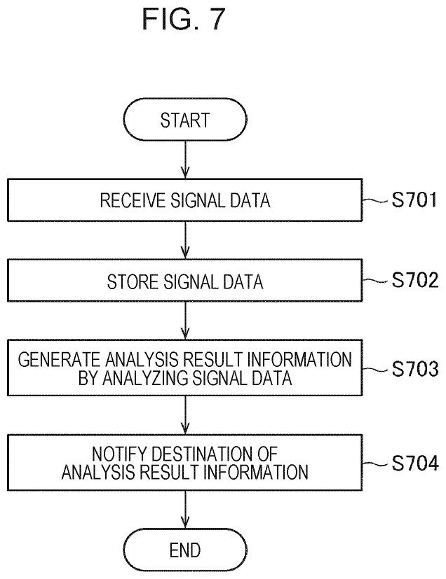

FIG. 7 is a flowchart illustrating an example of the process of the server apparatus 103.

In step S701, the communication unit 502 receives the signal data 112.

In step S702, the data analyzer 511 stores the received signal data 112 on the server memory 501.

In step S703, the data analyzer 511 generates the analysis result information 521 by analyzing the signal data 112 stored on the server memory 501. When the data analyzer 511 has stored the signal data 112 multiple times on the server memory 501, the data analyzer 511 generates the analysis result information 521 by analyzing the stored signal data 112. For example, when the server apparatus 103 stores the identification information on the transmission terminal 101 in association with the position information on the transmission terminal 101, the data analyzer 511 fixes the position of the communication terminal 102 in accordance with the identification information and reception strength indicated by the signal data 112. In such a case, the analysis result information 521 indicates the fixed position.

In the communication system 100 of the embodiment, since the communication terminal 102 transmits to the server apparatus 103 the signal data 112 including a set of identification information 315 and reception strength 316 of the signal 111 and the server apparatus 103 fixes the position of the communication terminal 102, a processing load of the communication terminal 102 becomes relatively lower. In this way, in the communication system 100 of the embodiment, the communication terminal 102 may be easily mounted as a wearable device. As a result, the server apparatus 103 may fix the position of a person who wears the communication terminal 102 mounted as a wearable device.

In step S704, the notifier 512 notifies the specific destination of the analysis result information 521. For example, upon receiving a request signal from the administrator or the like of the server apparatus 103, the notifier 512 notifies the specific destination of the analysis result information 521 at every specific timing.

FIG. 8 is a diagram illustrating an example of a reception time period 801a, a reception time period 802a, a data transmission time period 801b, and a data transmission time period 802b. The data transmission time period 801b and the data transmission time period 802b indicate time periods while the communication terminal 102 transmits the signal data 112 to the server apparatus 103. A data transmission time interval indicates a time period from the end of the transmission operation of the signal data 112 to the end of the transmission operation of the next signal data 112.

Referring to FIG. 8, the communication terminal 102 receives the signal 111 during the reception time period 314 in order to transmit the signal data 112 to the server apparatus 103 at every data transmission interval.

FIG. 8 further illustrates an example of the scan interval 311 on each channel within the reception time period 801a and received signals 111. For example, the transmission interval may now be 250 ms, the scan interval 311 may now be 500 ms, and channels as selection targets are channel 37-channel 39. In such a case, as illustrated in FIG. 8, the reception unit 303 receives the signals 111 on different channels during a time period extending across multiple scan intervals 311 where channel 37-channel 39 are respectively selected.

As described above, the communication terminal 102 of the embodiment receives the signals 111 on the different channels during the reception time period 314 extending across the scan intervals 311. Although the reception strength varies depending channel difference, variations in the reception strength 316 may be reduced by receiving the signals 111 during the reception time period 314 extending across the multiple scan intervals 311. Furthermore, the communication terminal 102 of the embodiment may reduce an increase in power consumption by receiving sufficient signals 111 during the reception time period 314 while reducing the variations in the reception strength 316.

Also, the server apparatus 103 of the embodiment analyzes the multiple signals 111 received during the reception time period 314. As a result, the server apparatus 103 may fix the position of the communication terminal 102 from sufficient signals 111 for position fixing while reducing the variations in the reception strength 316 caused by channel difference.

Therefore, the communication system 100 of the embodiment acquires the signals 111 within a relatively shorter time period in the position fixing based on the reception strength of the signal 111. The communication system 100 may ensure accuracy of a fixed position while reducing the increase in the power consumption.

With the communication terminal 102 in motion, the position fixing based on the reception strength of the signal 111 may have a larger error as the reception time period becomes longer. However, the communication system 100 of the embodiment may preclude the reception time period 314 from becoming unnecessarily long while reducing the variations in the reception strength 316 caused by channel difference.

Accuracy in the position fixing may be ensured with the communication terminal 102 in the motion state.

### Second Embodiment

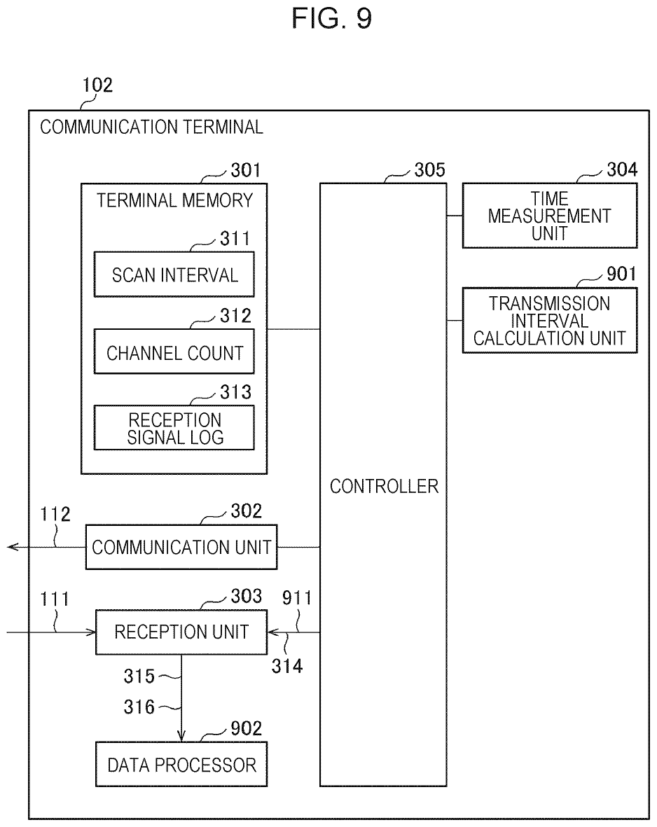

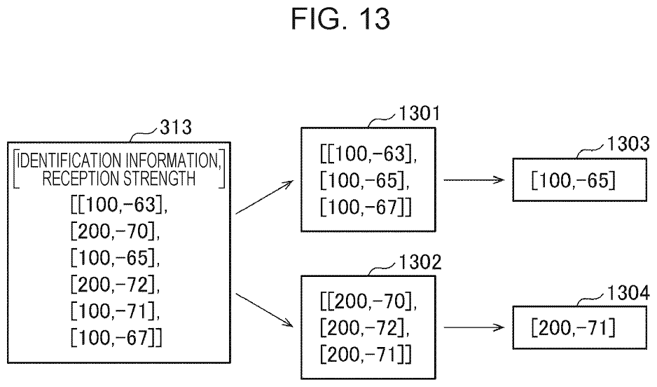

Second embodiment is described with reference to FIG. 9 FIG. 13. In the drawings, elements that are the same or similar to each other are designated with the same reference numerals and the explanation thereof is not duplicated. Configurations and processes having functions substantially common to those in other embodiments are designated with the same reference numerals and the explanation thereof is not duplicated and a difference from the other embodiments is described.

FIG. 9 is a block diagram illustrating an example of the configuration of the communication terminal 102 of the embodiment. The difference between the communication terminal 102 illustrated in FIG. 9 and the communication terminal 102 illustrated in FIG. 3 is that the communication terminal 102 illustrated in FIG. 9 includes a transmission interval calculation unit 901 and a data processor 902 in place of the data processor 306.

The transmission interval calculation unit 901 calculates a transmission interval 911 at which the transmission terminal 101 transmits the signal 111 such that the reception count of the signal 111 in each scan interval 311 equals among the multiple scan intervals 311. The transmission interval calculation unit 901 causes the terminal memory 301 to store the calculated transmission interval 911.

The controller 305 of the embodiment causes the reception unit 303 to receive the signal 111 at the transmission interval 911.

When the reception unit 303 has received the signal 111 multiple times, the data processor 902 calculates the mean value of the reception strengths 316 of the signals 111 including the identical identification information 315. The data processor 902 then generates signal data 903. The signal data 903 includes a set of identification information 315 and calculated mean value. The count of the signal data 903 herein is lower than the count at which the signal 111 is received during the reception time period 314. Also, the count of the signal data 903 is different depending on the position fixing method through which the server apparatus 103 fixes the position of the communication terminal 102. For example, the communication terminal 102 transmits to the server apparatus 103 a datum having the highest strength, as the signal data 903, from among data having undergone an average operation, and the server apparatus 103 fixes the position of the communication terminal 102 in accordance with the received signal datum 903. For example, the communication terminal 102 transmits to the server apparatus 103 a specific number of data having a relatively higher strength, as the signal data 903, from among the data having undergone the average operation and the server apparatus 103 may fix the position of the communication terminal 102 in accordance with the specific number of signal data 903.

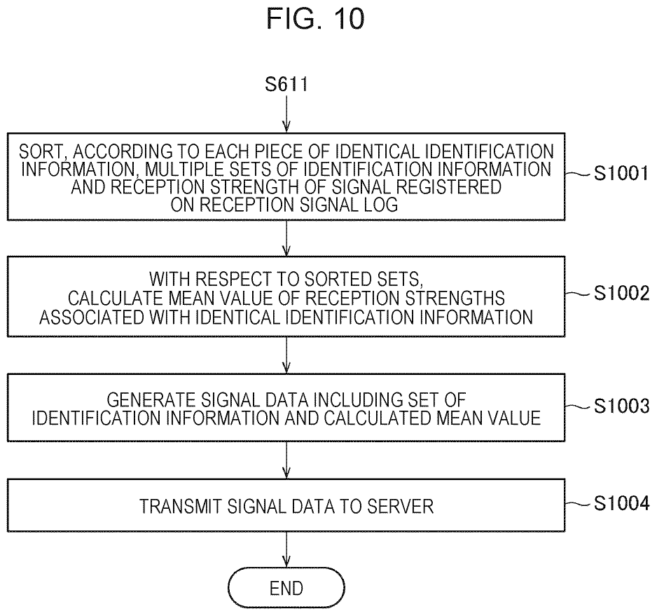

FIG. 10 is a flowchart illustrating an example of the process of the communication terminal 102 of the embodiment. Before the controller 305 starts the operation in step S601 illustrated in FIG. 6, the transmission interval calculation unit 901 calculates the transmission interval 911 such that the multiple scan intervals 311 are equal to each other in terms of the reception count of the signals 111 received in each the scan interval 311. The transmission interval calculation unit 901 then sets the reception time period 314 to be the transmission interval of the beacon x the channel count and the integer. When the reception time period 314 is set, the controller 305 starts the operation in step S601.

When the controller 305 causes the reception unit 303 to end the signal reception operation in step S611 illustrated in FIG. 6, the data processor 902 sorts in step S1001 multiple sets of identification information 315 and reception strength 316 registered on the reception signal log 313 according each piece of identical identification information 315.

In step S1002, with respect to the sets sorted in step S1001, the data processor 902 calculates the mean value of the reception strengths 316 associated with the identical identification information 315. In step S1003, the data processor 902 generates the signal data 903 including a set of identification information 315 and mean value calculated in step S1002.

In step S1004, the communication unit 302 transmits the signal data 903 to the server apparatus 103.

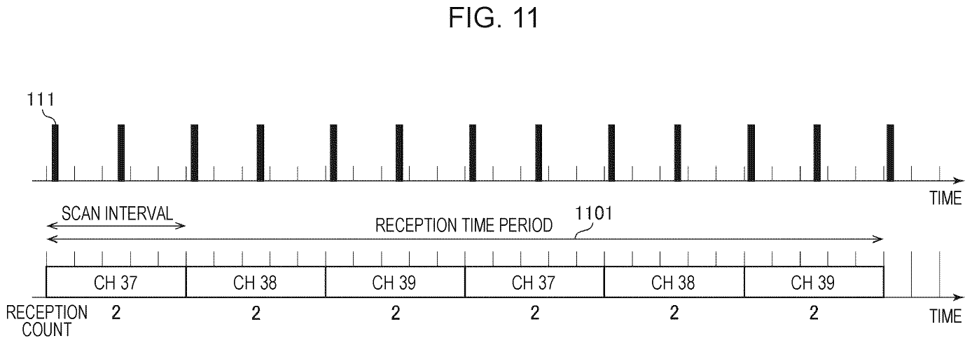

FIG. 11 is a diagram illustrating an example of the signal 111 that is received on each channel at the scan interval 311 in the communication terminal 102 of the second embodiment.

Reception time period 1101 illustrated in FIG. 11 extends across the multiple scan intervals 311 in which each of the channel 37-channel 39 is selected twice.

For example, if the scan interval 311 is 300 ms and the reception time period 1101 is 1800 ms, the transmission interval calculation unit 901 sets the transmission interval to 120 ms or 200 ms such that the reception count of the signal 111 is 2 at each scan interval 311. Also, for example, if the scan interval 311 is 500 ms and the reception time period 1101 is 3000 ms, the transmission interval calculation unit 901 sets the transmission interval to 200 ms such that the reception count of the signal 111 is 2 at each scan interval 311. Also, for example, if the scan interval 311 is 1000 ms and the reception time period 1101 is 6000 ms, the transmission interval calculation unit 901 sets the transmission interval to 400 ms such that the reception count of the signal 111 is 2 at each scan interval 311. Note that the reception time period 1101 may be set to a period extending across the multiple scan intervals 311 in which each of the channel 37-channel 39 is selected once. For example, if the scan interval 311 is 500 ms and the beacon transmission interval is 100 ms, the transmission interval calculation unit 901 may set the reception time period 1101 to 1500 ms such that each of the channel 37-channel 39 is selected once.

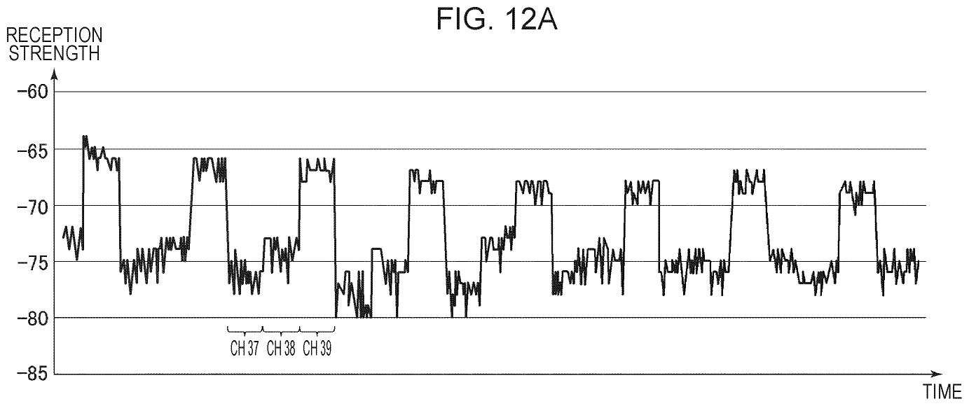

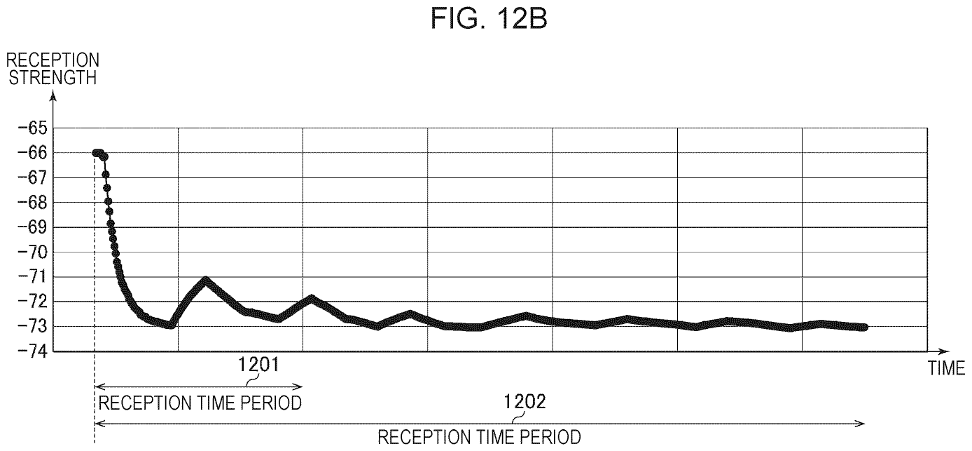

FIG. 12A is a graph illustrating an example of time variations in the reception strength 316. As illustrated in FIG. 12A, the horizontal axis represents time and the vertical axis represents the reception strength. Referring to FIG. 12A, the range of the reception strength 316 is different depending on channel.

FIG. 12B is a graph illustrating an example of the time variation of the mean value in the reception strength 316. As illustrated in FIG. 12B, the horizontal axis represents time and the vertical axis represents the reception strength. Referring to FIG. 12B, when the transmission intervals are equal to each other, a data quantity to be averaged becomes larger when the signal 111 is received during a reception time period 1202 longer than a reception time period 1201 than when the signal 111 is received during the reception time period 1201. As a result, in comparison when the signal 111 is received during the reception time period 1201, the mean value of the reception strength 316 converges when the signal 111 is received during the reception time period 1202 as illustrated in FIG. 12B. In other words, accuracy may be increased by increasing the data quantity. However, as the reception time period 1101 is relatively longer, power consumption increases. For example, when the reception time period 1101 is the product of the scan interval 311, the channel count 312, and the specific multiple N, the power consumption increases if the specific multiple N is too high. For example, the upper limit value of the specific multiple N is desirably N=5. Furthermore, when the server apparatus 103 performs position fixing in accordance with the reception strength 316 of the signal 111 with the communication terminal 102 in motion, the movement amount of the communication terminal 102 increases as the reception time period 1101 is relatively longer and there is a possibility that an error in the position fixing increases. For this reason, the reception time period 1101 is desirably a time period needed for the mean value of the reception strength 316 to converge.

FIG. 13 illustrates an example of operations in step S1001-step S1002 illustrated in FIG. 10. On the reception signal log 313 illustrated in FIG. 13, the identification information 315 indicating 100 is registered in association with the reception strength 316 and the identification information 315 indicating 200 is registered in association with the reception strength 316.

In step S1001, the data processor 902 sorts the sets of identification information 315 and reception strength 316 registered on the reception signal log 313 into multiple sets 1301 and multiple sets 1302. The sets 1301 include the sets of identification information 315 indicating 100 and reception strengths 316. Specifically, the sets 1301 include the sets of identification information 315 indicating 100 and reception strengths 316 having −63 dBm, −65 dBm, and −67 dBm. The sets 1302 include the sets of identification information 315 indicating 200 and reception strengths 316. Specifically, the sets 1302 include the sets of identification information 315 indicating 200 and reception strengths 316 having −70 dBm, −72 dBm, and −71 dBm.

Then in step S1002, the data processor 902 calculates a mean value of reception strengths 316 concerning the sets 1301 of identification information 315 indicating 100 and reception strengths 316 and thus generates a set 1303 of the identification information 315 indicating 100 and −65 dBm as the calculated mean value. The data processor 902 further calculates a mean value of reception strengths 316 concerning the sets 1302 of identification information 315 indicating 200and reception strengths 316 and thus generates a set 1304 of identification information 315 indicating 200 and −71 dBm as the calculated mean value.

As described above, the communication terminal 102 of the embodiment receives the signals 111 at the same intervals as the multiple scan intervals 311 and calculates the mean value of the reception strengths 316 of the signals 111 including the identical identification information 315. The communication terminal 102 of the embodiment transmits to the server apparatus 103 the identification information 315 and the signal data 112 associated with the calculated mean value. In this way, the server apparatus 103 of the embodiment may fix the position of the communication terminal 102 by reducing even more the variations in the reception strengths 316 caused by channel difference.

### Third Embodiment

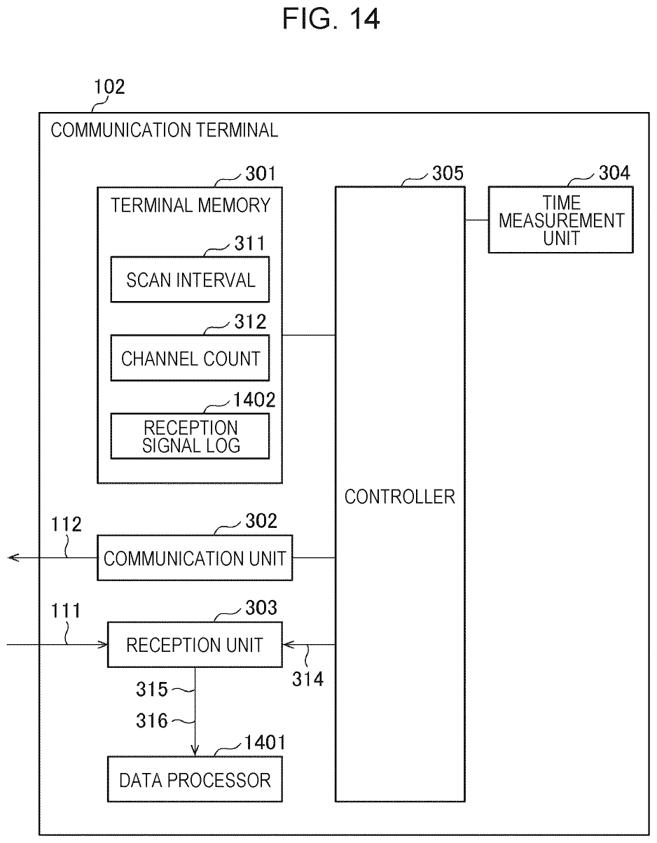

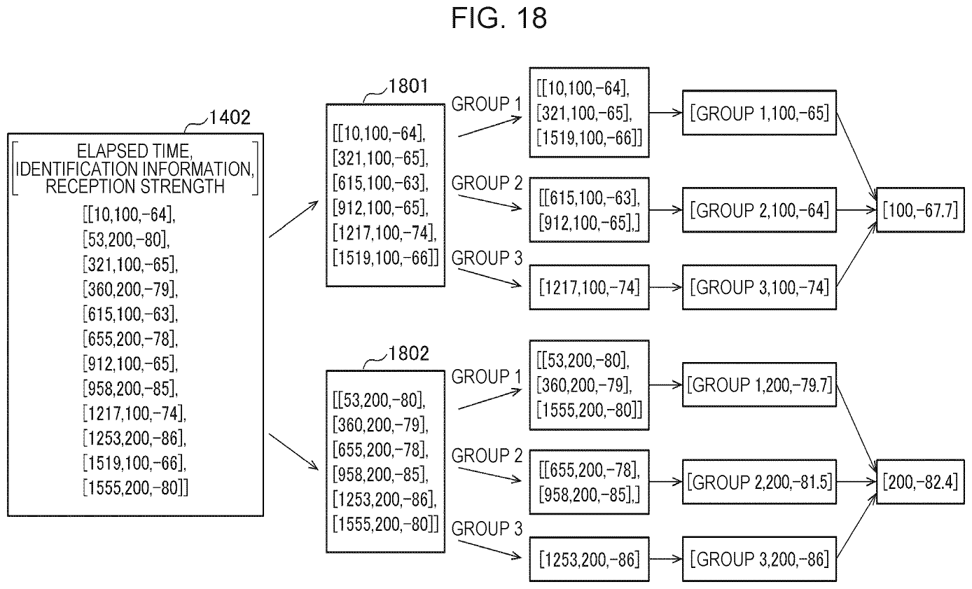

Third embodiment is described with reference to FIG. 14 FIG. 18. In the drawings, elements that are the same or similar to each other are designated with the same reference numerals and the explanation thereof is not duplicated. Configurations and operations having functions substantially common to those in other embodiments are designated with the same reference numerals and the explanation thereof is not duplicated and a difference from the other embodiments is described.

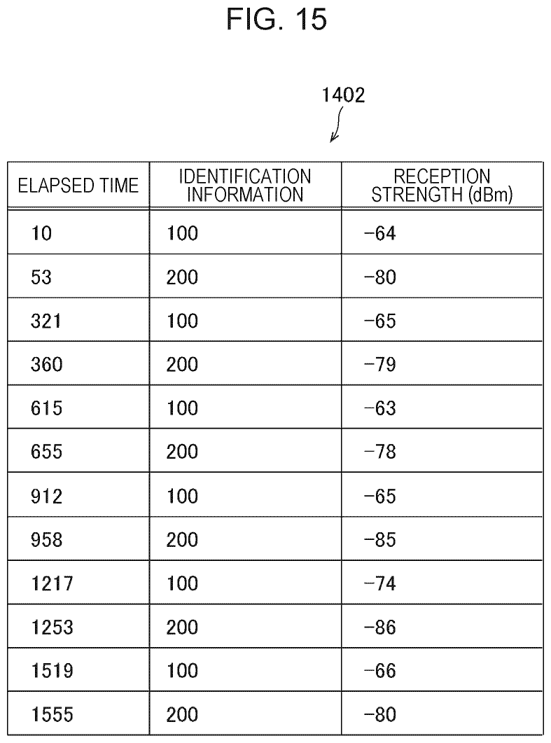

FIG. 14 is a block diagram illustrating an example of the configuration of the communication terminal 102 of the embodiment. The difference between the communication terminal 102 illustrated in FIG. 14 and the communication terminal 102 illustrated in FIG. 3 is that the communication terminal 102 illustrated in FIG. 14 includes a data processor 1401 in place of the data processor 306 and the terminal memory 301 stores a reception signal log 1402 (see FIG. 15) in place of the reception signal log 313.

When multiple signals 111 including the identical identification information 315 are sorted into multiple groups according to a quotient that results from dividing elapsed time from the start time point of the reception time period 314 by the scan interval 311, the data processor 1401 calculates a first mean value of the reception strengths 316 of the signals 111 belonging each of the groups. The groups are groups that are sorted according to a quotient that results from dividing by the channel count 312 the quotient that results from dividing the elapsed time from the start time point of the reception time period 314 by the scan interval 311. The data processor 1401 calculates a second mean value that is a mean value of the first mean values. The data processor 1401 then generates the signal data 112 including a set of identification information 315 and second mean value.

FIG. 15 is a diagram illustrating an example of the reception signal log 1402. On the reception signal log 1402, the elapsed time from the start time point of the reception time period 314 is associated with the identification information 315 on the signal 111 and the reception strength 316 of the signal 111. With respect to the signal 111 on the reception signal log 1402 received from the start time point of the reception time period 314 to the end time point of the reception time period 314, the elapsed time from the start time point of the reception time period 314 is associated with the identification information 315 on the signal 111 and the reception strength 316 of the signal 111.

For example, the reception signal log 1402 indicates that the signals 111 including the identification information 315 indicating 100 are received by the reception unit 303 at the elapsed times of 10 ms, 321 ms, 615 ms, 912 ms, 1217 ms, and 1519 ms from the start time point of the reception time period 314. Furthermore, the reception signal log 1402 indicates that the signals 111 including the identification information 315 indicating 200 are received by the reception unit 303 at the elapsed times of 53 ms, 360 ms, 655 ms, 958 ms, 1253 ms, and 1555 ms from the start time point of the reception time period 314.

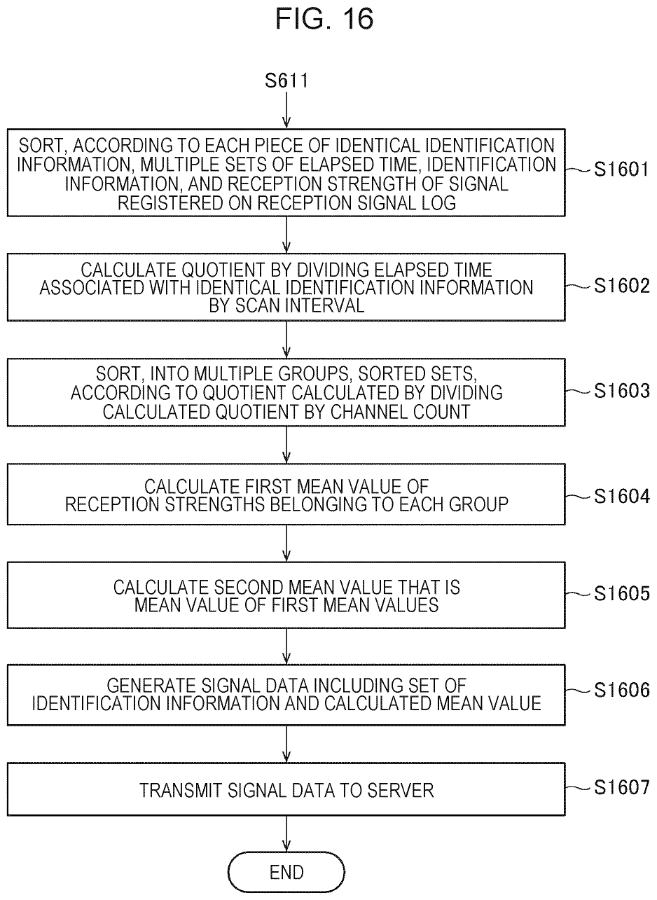

FIG. 16 is a flowchart illustrating an example of the process of the communication terminal 102 of the embodiment.

When the controller 305 causes the reception unit 303 to end the signal reception operation in step S611 as illustrated in FIG. 6, the data processor 1401 sorts, according to each piece of identical identification information 315 in step S1601, multiple sets of identification information 315 and reception strength 316 registered on the reception signal log 1402.

In step S1602, with respect to the sets sorted in step S1001, the data processor 1401 calculates a quotient that results from dividing by the scan interval 311 the elapsed time associated with the identical identification information 315.

In step S1603, the data processor 1401 sorts the sorted sets into multiple groups according to a quotient that results from dividing the calculated quotient by the channel count 312.

In step S1604, the data processor 1401 calculates a first mean value of the reception strengths 316 belonging to each of the sorted groups.

In step S1605, the data processor 1401 calculates a second mean value that is a mean value of the first mean values of each group.

In step S1606, the data processor 1401 generates the signal data 112 including a set of identification information 315 and second mean value.

In step S1607, the communication unit 302 transmits the signal data 112 to the server apparatus 103.

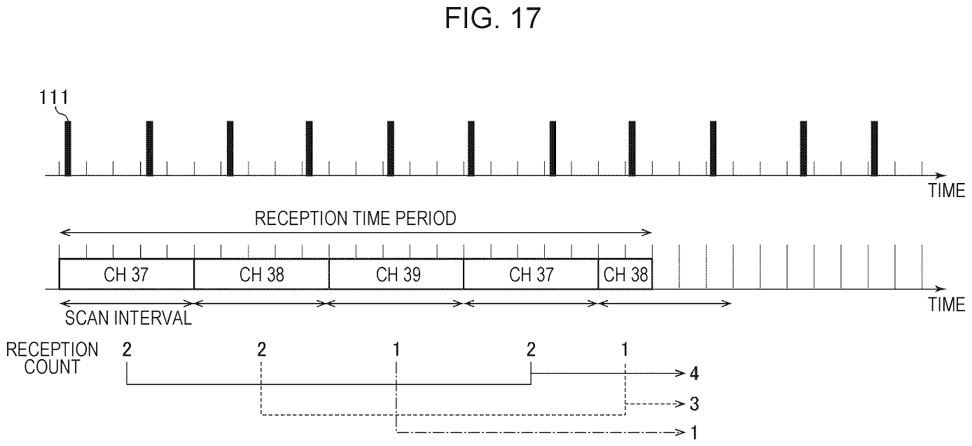

FIG. 17 illustrates an example of the scan intervals 311 and the signals 111 received during the reception time period 314 on each channel in the communication terminal 102 of the embodiment. The reception count of the signals 111 received on the channel 37 is 4. The reception count of the signals 111 received on the channel 38 is 3. The reception count of the signals 111 received on the channel 39 is 1. Since the reception count may not be the same on each channel but may be varied in the communication terminal 102 of the embodiment, the freedom of the reception time period 314 and the freedom of the transmission interval may be increased more than in the communication terminal 102 of the second embodiment.

FIG. 18 is an example of operations in step S1601-step S1605 illustrated in FIG. 16. On the reception signal log 1402 illustrated in FIG. 18, the elapsed time from the start time point of the reception time period 314 is registered in association with the identification information 315 indicating 100 and the reception strength 316, and the elapsed time from the start time point of the reception time period 314 is registered in association with the identification information 315 indicating 200 and the reception strength 316.

In step S1601, the data processor 1401 sorts, into sets 1801 and sets 1802, the elapsed times, the identification information 315 and the reception strengths 316 registered on the reception signal log 1402.

Each of the sets 1801 includes the elapsed time, the identification information 315 indicating 100, and the reception strength 316. Specifically, the sets 1801 include the elapsed times of 10 ms, 321 ms, 615 ms, 912 ms, 1217 ms, and 1519 ms, the identification information 315 indicating 100, and the reception strengths 316 respectively associated with each other.

Each of the sets 1802 includes the elapsed time, the identification information 315 indicating 100, and the reception strength 316. Specifically, the sets 1802 include the elapsed times of 53 ms, 360 ms, 655 ms, 958 ms, 1253 ms, and 1555 ms, the identification information 315 indicating 200, and the reception strengths 316 respectively associated with each other.

In step S1602, the data processor 1401 calculates a quotient that results from dividing the elapsed time by the scan interval 311 with respect to the sets 1801. For example, when the scan interval 311 is 500 ms, the data processor 1401 calculates in the sets 1801 quotients that result from respectively dividing the elapsed times of 10 ms, 321 ms, 615 ms, 912 ms, 1217 ms, and 1519 ms by 500 ms. In step S1603, the data processor 1401 divides the calculated quotient by 3 as the channel count 312 to sort into group 1-group 3.

Similarly, in step S1602, the data processor 1401 calculates a quotient that results from dividing the elapsed time by the scan interval 311 with respect to the sets 1802. For example, when the scan interval 311 is 500 ms, the data processor 1401 calculates in the sets 1802 quotients that result from respectively dividing 53 ms, 360 ms, 655 ms, 958 ms, 1253 ms, and 1555 ms by 500 ms. In step S1603, the data processor 1401 divides the calculated quotient by 3 as the channel count 312 to sort into group 1-group 3.

In step S1604, with respect to the group 1-group 3 in which the elapsed time, the identification information 315 indicating 100, and the reception strength 316 are associated with each other, the data processor 1401 calculates the first mean value of the reception strengths 316 belonging to each group and associates the identification information 315 with the first mean value. Specifically, with respect to the group 1, the data processor 1401 associates the identification information 315 indicating 100 with −65 dBm as the first mean value. Also, with respect to the group 2, the data processor 1401 associates the identification information 315 indicating 100 with −64 dBm as the first mean value. And yet, with respect to the group 3, the data processor 1401 associates the identification information 315 indicating 100 with −74 dBm as the first mean value.

Similarly, in step S1604, with respect to the group 1-group 3 in which the elapsed time, the identification information 315 indicating 200, and the reception strength 316 are associated with each other, the data processor 1401 calculates the first mean value of the reception strengths 316 belonging to each group and associates the identification information 315 with the first mean value. Specifically, with respect to the group 1, the data processor 1401 associates the identification information 315 indicating 200 with −79.7 dBm as the first mean value. Also, with respect to the group 2, the data processor 1401 associates the identification information 315 indicating 200 with −81.5 dBm as the first mean value. And yet, with respect to the group 3, the data processor 1401 associates the identification information 315 indicating 200 with −86 dBm as the first mean value.

In step S1605, the data processor 1401 calculates a second mean value that is a mean value of the first mean values associated with the identification information 315 indicating 100. Specifically, the data processor 1401 calculates the second mean value related to the identification information 315 indicating 100, thus a mean value −67.7 dBm of −65 dBm, −64 dBm, and −74 dBm associated with the identification information 315 indicating 100. Similarly, in step S1605, the data processor 1401 calculates the second mean value related to the identification information 315 indicating 200, thus a mean value −82.4 dBm of −79.7 dBm, −81.5 dBm, and −86 dBm associated with the identification information 315 indicating 200.

As described above, the communication terminal 102 of the embodiment divides the reception strengths 316 according to the elapsed time from the start time point of the reception time period 314 and calculates the mean value of the reception strengths 316. In this way, the communication terminal 102 of the embodiment may appropriately calculate the mean value of the calculated reception strengths 316 even when the reception count of the signal 111 is different among the multiple scan intervals 311.

### Fourth Embodiment

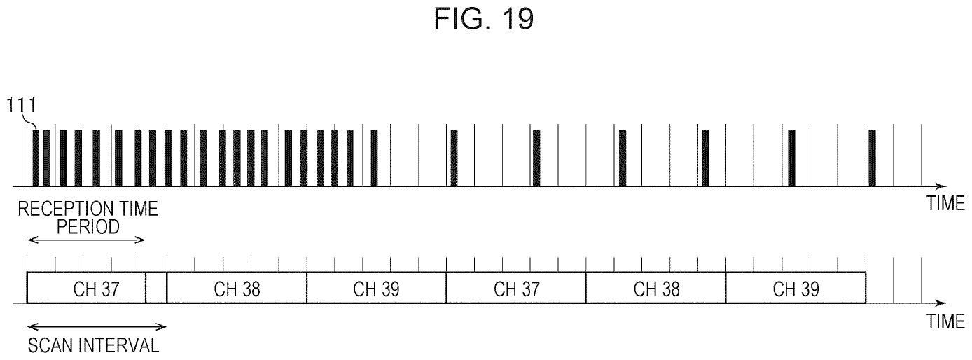

Fourth embodiment is described with reference to FIG. 19. In the drawings, elements that are the same or similar to each other are designated with the same reference numerals and the explanation thereof is not duplicated. Configurations and processes having functions substantially common to those in other embodiments are designated with the same reference numerals and the explanation thereof is not duplicated and a difference from the other embodiments is described.

The configuration of the communication terminal 102 of the embodiment is identical to the configuration of the communication terminal 102 illustrated in FIG. 3.

The controller 305 of the embodiment causes the reception unit 303 to receive the signal 111 during the reception time period 314 that is shorter than the scan interval 311 and during which the reception count of the signal 111 exceeds a threshold.

When the reception unit 303 receives the signal 111 at the reception count exceeding the threshold during the reception time period 314 shorter than the scan interval 311, the data processor 306 of the embodiment registers on the reception signal log 313 the identification information 315, included in the signal 111 received during the reception time period 314, in association with the reception strength 316 of the signal 111.

FIG. 19 illustrates an example of the scan interval 311 and the signal 111 received during the reception time period 314 in the communication terminal 102 of the embodiment. For example, when the reception unit 303 receives the signal 111 at a reception count of 7 in excess of the threshold during the reception time period 314 shorter than the scan interval 311, the identification information 315 on the signal 111 is registered in association with the reception strength 316 on the reception signal log 313. Since the reception time period 314 is herein a time period within which the reception count of the signal 111 is in excess of the threshold, the communication terminal 102 of the embodiment may be free from measuring the elapsed time from the time point at the start of the signal reception operation.

Since the communication terminal 102 of the embodiment does not receive the signal 111 during the time period across the multiple scan intervals 311 as described above, the variations in the reception strength 316 may be even more reduced. Furthermore, the communication terminal 102 of the embodiment may set the reception time period 314 to be shorter than when the signal 111 is received during the time period extending across the multiple scan intervals 311 and power consumption may be even more reduced.

### Fifth Embodiment

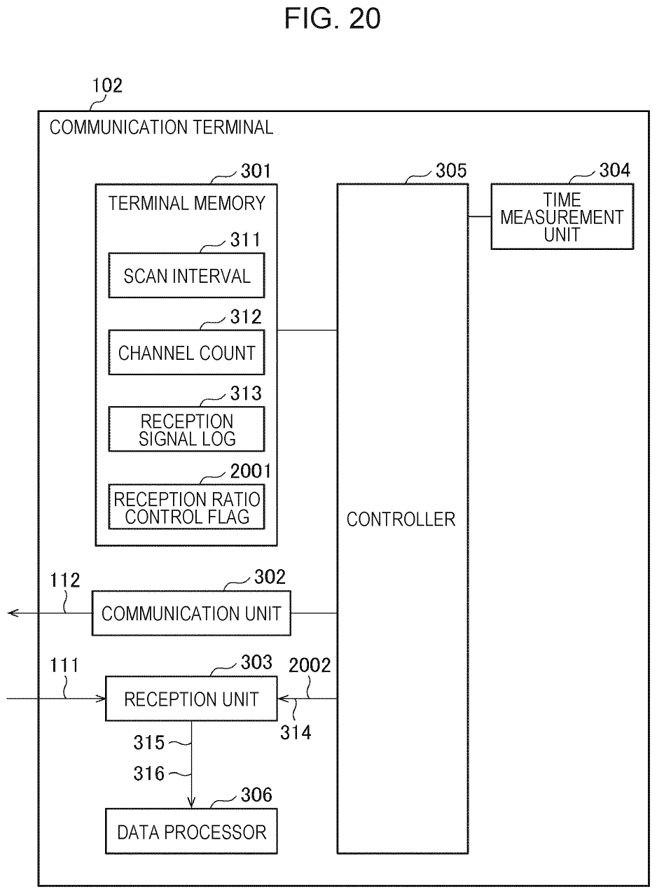

Fifth embodiment is described with reference to FIG. 20 FIG. 23. In the drawings, elements that are the same or similar to each other are designated with the same reference numerals and the explanation thereof is not duplicated. Configurations and processes having functions substantially common to those in other embodiments are designated with the same reference numerals and the explanation thereof is not duplicated and a difference from the other embodiments is described.

FIG. 20 is a block diagram illustrating an example of the configuration of the communication terminal 102 of the embodiment. The difference between the communication terminal 102 illustrated in FIG. 20 and the communication terminal 102 illustrated in FIG. 3 is that the terminal memory 301 stores a reception ratio control flag 2001 in the communication terminal 102 illustrated in FIG. 20. The reception ratio control flag 2001 indicates a value used to control a reception ratio 2002.

When the elapsed time from the start time point of the reception time period 314 exceeds a specific time period, the controller 305 of the embodiment controls the reception ratio 2002 within the scan interval 311 in response to the reception count of the signal 111. Specifically, when the elapsed time from the start time point of the reception time period 314 exceeds the specific time period and the reception count is equal to or lower than 1, the controller 305 causes the reception unit 303 to receive the signal 111 such that the reception ratio 2002 increases. Also, when the elapsed time from the start time point of the reception time period 314 exceeds the specific time period and the reception count is higher than 1 and equal to or higher than 2, the controller 305 causes the reception unit 303 to receive the signal 111 such that the reception ratio 2002 decreases.

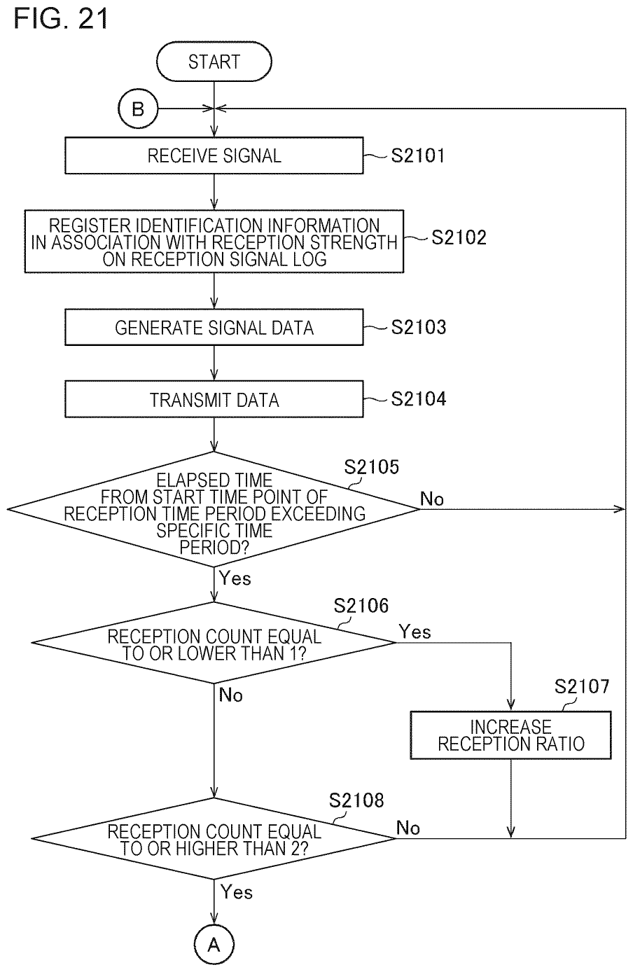

FIG. 21 is a flowchart illustrating an example of the process of the communication terminal 102 of the embodiment. At the time when the controller 305 starts an operation in step S2101, the value indicated by the reception ratio control flag 2001 is 0.

In step S2101, the controller 305 causes the reception unit 303 to receive the signal 111.

In step S2102, the data processor 306 registers on the reception signal log 313 the identification information 315 included in the received signal 111 in association with the reception strength 316 of the signal 111.

In step S2103, the data processor 306 generates the signal data 112 including a set of identification information 315 and reception strength 316 registered on the reception signal log 313. In step S2104, the communication unit 302 transmits the signal data 112 to the server apparatus 103.

In step S2105, the controller 305 determines whether the elapsed time from the start time point of the reception time period 314 exceeds a specific time period. If the elapsed time from the start time point of the reception time period 314 does not exceed the specific time period in step S2105, the controller 305 returns to the operation in step S2101. On the other hand, if the elapsed time from the start time pint of the reception time period 314 exceeds the specific time period in step S2105, the controller 305 proceeds to an operation in step S2106.

In step S2106, the controller 305 determines whether the reception count is equal to or lower than 1. If the reception count is equal to or lower than 1 in step S2106, the controller 305 causes in step S2107 the reception unit 303 to receive the signal 111 such that the reception ratio 2002 increases. For example, by raising the reception sensitivity of the reception unit 303 for the signal 111, the controller 305 increases the reception ratio 2002. The raise rate of the reception ratio 2002 is, for example, 10%. The controller 305 then returns to the operation in step S2101. On the other hand, if the reception count is in excess of 1 in step S2106, the controller 305 proceeds to an operation in step S2108.

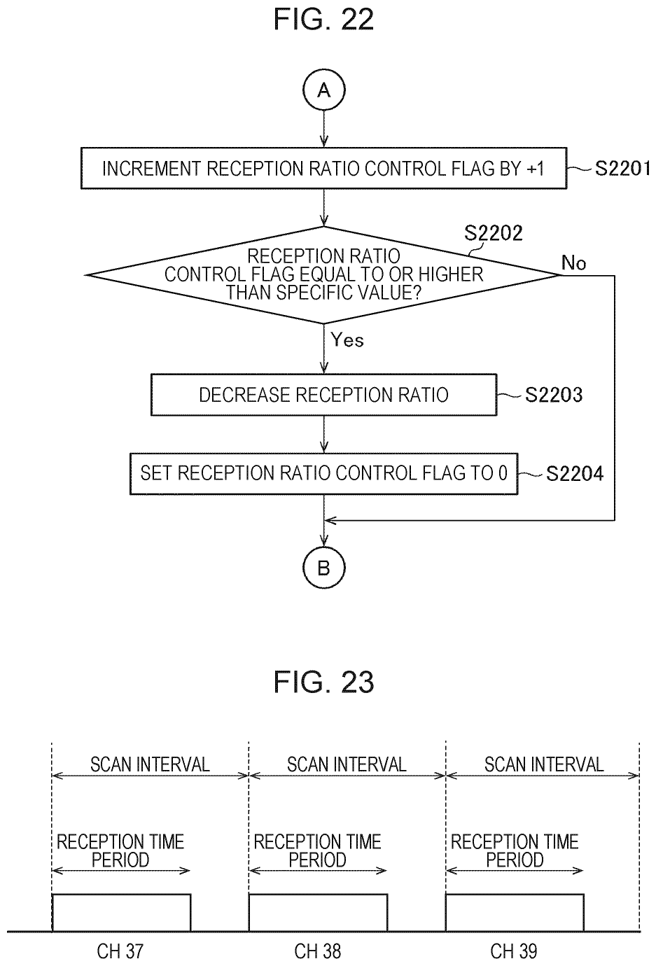

In step S2108, the controller 305 determines whether the reception count is higher than 1 and equal to or higher than 2. If the reception count is lower than 2 in step S2108, the controller 305 returns to the operation in step S2101. On the other hand, if the reception count is equal to or higher than 2 in step S2108, the controller 305 proceeds to an operation in step S2201 illustrated in FIG. 22.

Next, referring to FIG. 22, the process of the communication terminal 102 of the embodiment is continuously described.

In step S2201, the controller 305 increments the value indicated by the reception ratio control flag 2001 by +1.

In step S2202, the controller 305 determines whether the value indicated by the reception ratio control flag 2001 is equal to or higher than a specific value. If the value indicated by the reception ratio control flag 2001 is lower than the specific value in step S2202, the controller 305 returns to the operation in step S2101 illustrated in FIG. 21. On the other hand, if the value indicated by the reception ratio control flag 2001 is equal to or higher than the specific value in step S2202, the controller 305 proceeds to an operation in step S2203.

In step S2203, the controller 305 causes the reception unit 303 to receive the signal 111 such that the reception ratio 2002 decreases. For example, by lowering the reception sensitivity of the reception unit 303 for the signal 111, the controller 305 lowers the reception ratio 2002. The lower rate of the reception ratio 2002 is, for example, 10%. In step S2204, the controller 305 then sets the value indicated by the reception ratio control flag 2001 to 0. The controller 305 then proceeds to the operation in step S2101 illustrated in FIG. 21.

FIG. 23 illustrates an example of the scan intervals 311 and the reception time periods 314 in the communication terminal 102 of the embodiment. The controller 305 controls the reception ratio 2002 in accordance with the reception count when the elapsed time from the start time point of the reception time period 314 exceeds the specific time period. In this way, as illustrated in FIG. 23, the controller 305 causes the reception unit 303 to receive the signal 111 for a time period shorter than the scan interval 311 on each channel.

After causing the reception unit 303 to receive the signal 111 on each channel, the controller 305 lowers the reception ratio 2002 not to receive the signal 111 until the reception unit 303 switches the selected channels. In this way, the communication terminal 102 of the embodiment may reduce power consumption more than the communication terminal 102 in the other embodiments.

The operations performed in the embodiments are limited to operations modes described in connection with the embodiments. The functional blocks described above may be implemented using any of a logic circuit (hardware) formed on an integrated circuit or the like or software based on CPU. The operations performed in the embodiments described above may be performed using multiple computers. For example, the operation performed on each functional block of the controller 305 in the communication terminal 102 may be partially performed by another computer or all the operations may be performed by multiple computers in a distributed fashion.

The disclosure is not limited to the embodiments and the configurations of the embodiments may be substituted for configurations substantially identical to the configurations of the embodiments, configurations having the same operations and effects as the embodiments, or configurations capable of accomplishing the same object as the embodiments. With respect to the disclosure, an embodiment implemented by combining technical means respectively disclosed in the different embodiments may fall into the technical scope of the disclosure. Furthermore, a new technical feature may be formed by combining the technical means respectively disclosed in the embodiments.

1. A communication terminal comprising:
a reception unit that switches channels for selection from a plurality of channels on a per scan interval basis and receives a signal on the selected channel; and
a controller that causes the reception unit to receive the signal during a reception time period extending across a plurality of scan intervals at which the channels are respectively selected.

2. The communication terminal according to claim 1, wherein the signal includes identification information, and
wherein the communication terminal further comprises a data processor that, when the reception unit has received the signal a plurality of times, calculates a mean value of reception strengths of signals including identical identification information.

3. The communication terminal according to claim 2, further comprising a time measurement unit that measures elapsed time from a start time point of the reception time period,
wherein when a plurality of signals including the identical identification information are sorted into a plurality of groups according to a quotient that is obtained by dividing the elapsed time by the scan interval, the data processor calculates a first mean value of reception strengths of signals belonging to each of the groups.

4. The communication terminal according to claim 3, wherein the data processor calculates a second mean value that is a mean value of the first mean values.

5. The communication terminal according to Claim wherein the groups are groups that sorted according to a quotient that results from dividing by a count of the channels the quotient of the elapsed time divided by the scan interval.

6. A communication terminal comprising:
a reception unit that switches channels for selection from a plurality of channels on a per scan interval basis and receives at specific intervals a signal that is transmitted on the selected channel; and
a controller that causes the reception unit to receive the signal during a reception time period that is shorter than the scan interval and within which a count of receptions of the signal exceeds a threshold.

7. The communication terminal according to Claim wherein the controller controls, in a state that an elapsed time from a start time point of the reception time period is in excess of a specific time period, a reception ratio within the scan interval in accordance with a reception count at which the signal is received.

8. The communication terminal according to claim 7, wherein in the state that the elapsed time is in excess of the specific time period, the controller causes, if the reception count is equal to or lower than 1, the reception unit to receive the signal such that the reception ratio increases or causes, if the reception count is higher than 1 and equal to or higher than 2, the reception unit to receive the signal such that the reception ratio decreases.

9. A control method comprising:
switching channels for selection from a plurality of channels on a per scan interval basis and receiving a signal on the selected channel; and
controlling a reception time period extending across a plurality of scan intervals at which the channels are respectively selected, such that the signal is received during the reception time period.

10. A control method comprising:
switching channels for selection from a plurality of channels on a per scan interval basis and receiving at specific intervals a signal that is transmitted on the selected channel; and
controlling a reception time period such that the reception time period is shorter than the scan interval and a count of receptions of the signal exceeds a threshold within the reception time period.

11-12. (canceled)
